(19) United States
(12) Patent Application Publication
(10) Pub. No.: US 2010/0175513 A1
(43) Pub. Date: Jul. 15, 2010

(54) Wrench

(76) Inventor: Da-Sen LIN, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/351,896

(22) Filed: Jan. 12, 2009

(51) Int. Cl. B25B 13/08

(52) U.S. Cl. 81/120

(57) ABSTRACT

A wrench includes a handle and at least one head extending from an end of the handle. The head includes a driving portion formed thereon, a retreating portion formed near the driving portion and a mouth defined near the retreating portion. The driving portion of the head includes two parallel facets separated from each other by a gap. The retreating portion of the head is formed with two arched facets as two arcs of a circle with a diameter. The mouth is made with a width. The width is smaller than the gap that is smaller than the diameter.

### FIELD OF INVENTION

The present invention relates to a wrench and, more particularly, to a wrench that is engaged with a fastener during an active stroke and does not have to be completely disengaged from the fastener during an idle stroke opposite to the active stroke.

### BACKGROUND OF INVENTION

A conventional wrench such as the one disclosed in Taiwanese Patent M338722 includes at least one head. The head may be an open end or a boxed end. An open end of a wrench includes two jaws for close contact with two facets of fastener such as a nut or a threaded bolt. A boxed end of a wrench is in the form of a ring with recesses defined in an internal side thereof for receiving corners of a fastener. In either case, the head is engaged with the fastener during an active stroke and is completely disengaged from the fastener during an idle stroke opposite to the active stroke. To tighten or lose the fastener, it takes several active strokes and idle strokes. The repeated engagement and disengagement takes time. It requires concentration to reengage the head with fastener.

The present invention is therefore intended to obviate or at least alleviate the problems encountered in prior art.

### SUMMARY OF INVENTION

It is the primary objective of the present invention to provide a wrench that is engaged with a fastener during an active stroke and does not have to be completely disengaged from the fastener during an idle stroke opposite to the active stroke.

To achieve the foregoing objective, the wrench includes a handle and at least one head extending from an end of the handle. The head includes a driving portion formed thereon, a retreating portion formed near the driving portion and a mouth defined near the retaining portion. The driving portion of the head includes two parallel facets separated from each other by a gap. The retreating portion of the head is formed with two arched facets as two arcs of a circle with a diameter. The mouth is made with a width. The width is smaller than the gap that is smaller than the diameter.

Other objectives, advantages and features of the present invention will become apparent from the following description referring to the attached drawings.

### BRIEF DESCRIPTION OF DRAWINGS

The present invention will be described via detailed illustration of two embodiments referring to the drawings.

FIG. 1 is a perspective view of a wrench according to the first embodiment of the present invention.

FIG. 2 is a top view of a fastener engaged with the wrench shown in FIG. 1 during an active stroke.

FIG. 3 is a top view of the fastener and the wrench in a transient position between the active stroke and an idle stroke.

FIG. 4 is a top view of the fastener and the wrench during the idle stroke.

FIG. 5 is a top view of the fastener and the wrench during another active stroke.

FIG. 6 is a perspective view of a wrench according to the second embodiment of the present invention.

### DETAILED DESCRIPTION OF EMBODIMENTS

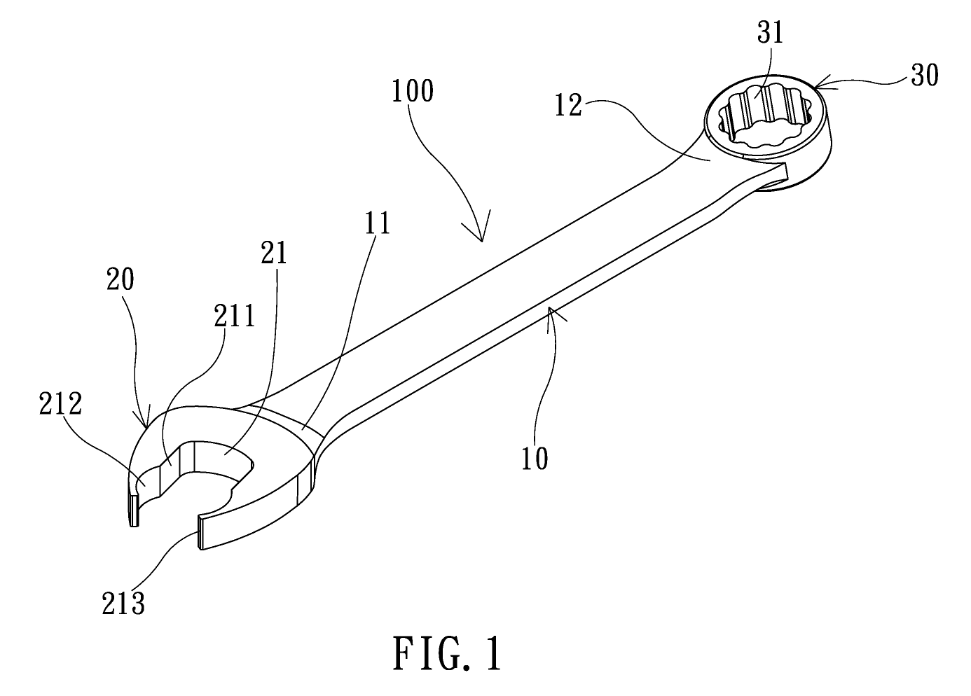

Referring to FIG. 1, a wrench 100 includes a handle 10, a first head 20 formed at a first end 11 of the handle 10 and a second head 30 formed at a second end 12 of the handle 10 according to a first embodiment of the present invention.

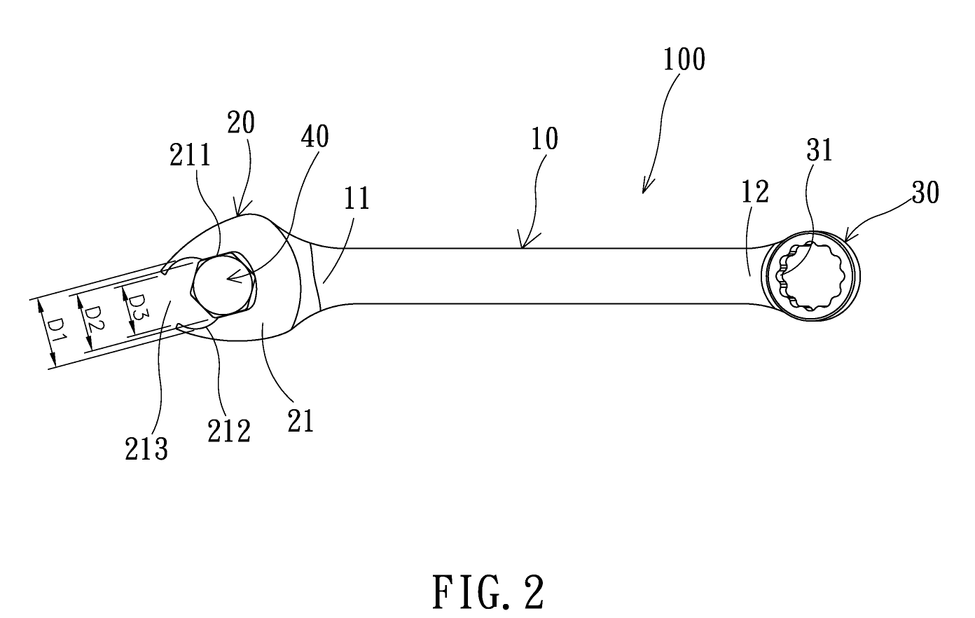

The first head 20 is an open end. The first head 20 includes a driving portion 21 thereon, a retreating portion 212 near the driving portion 21 and a mouth 213 near the driving portion 21. The driving portion 21 of the head 20 is shaped corresponding to a fastener 40 (see FIG. 2) such as a nut or a threaded bolt so that the former can be engaged with the latter during an active stroke. In detail, the driving portion 21 of the first head 20 includes two parallel planar facets 211 separated by a gap D2 marginally larger than a distance between two opposite facets of the fastener. The retreating portion 212 of the first head 20 includes two arched facets like two segments of a circle with a diameter D1 larger than the gap D2. The mouth 213 includes a width D3 smaller than the gap D2.

The second head 30 is in the form of a ring with recesses 31 defined in an internal side thereof. The second head 30 is like a closed end of a typical wrench so that it will not be described in detail.

Referring to FIG. 2, during the active stroke, the driving portion 21 of the first head 20 is engaged with the fastener 40. Thus, the wrench 100 is operable to drive the fastener 40.

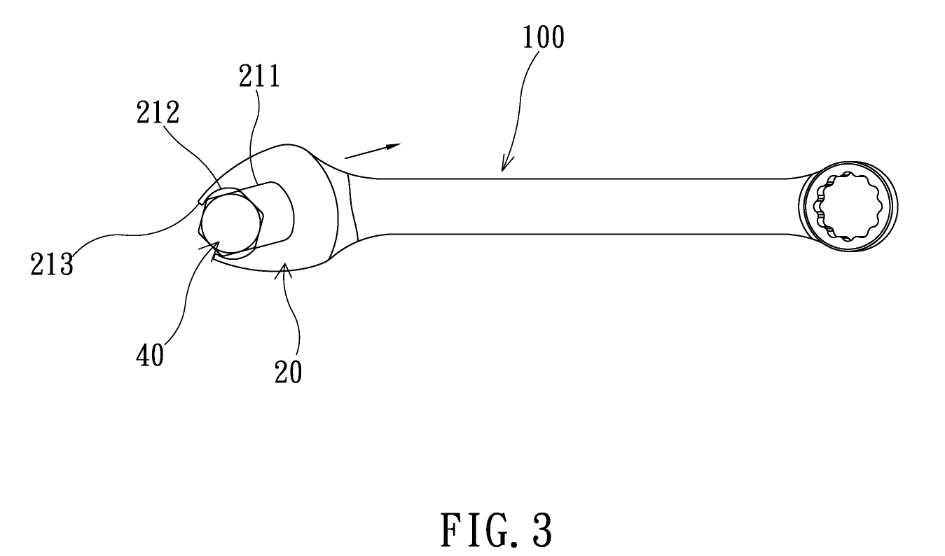

Referring to FIG. 3, by moving the wrench 100 in a direction indicated with an arrow, the driving portion 21 of the first head 20 is disengaged from the fastener 40 so that the fastener 40 is located within the retreating portion 212 of the first head 20. The wrench 100 is ready for the idle stroke. The first head 20 does not have to be disengaged from the fastener 40. A user does not have to be worried about disengaging the wrench 100 from the fastener 40 because the width D3 of the mouth 213 is made smaller than the distance between two opposite facets of the fastener 40, which is marginally smaller than the gap D2.

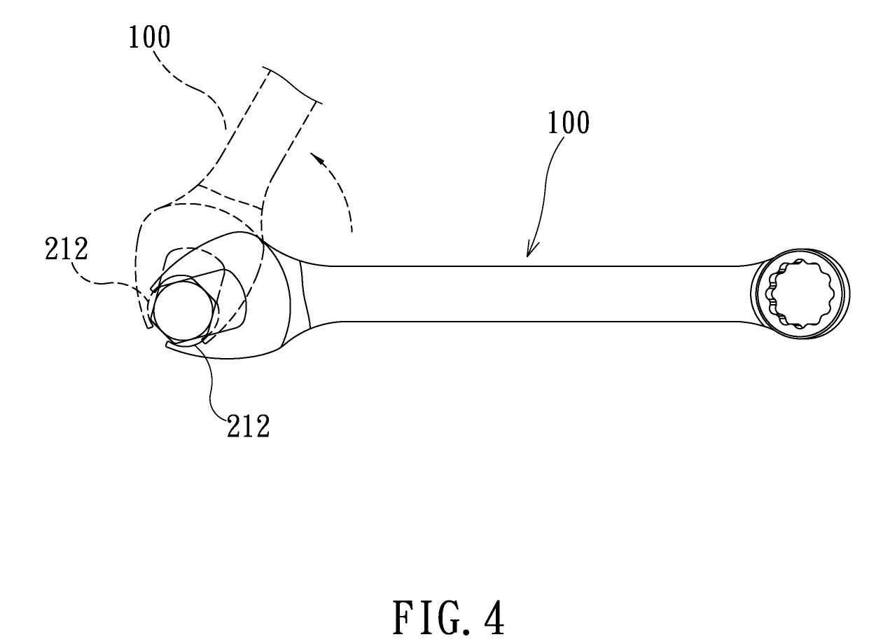

Referring to FIG. 4, during the idle stroke, the wrench 100 is pivoted in a direction indicated with an arrow head. The fastener 40 is not driven with the wrench 100 because the fastener 40 is located within the retreating portion 212 of the first head 20.

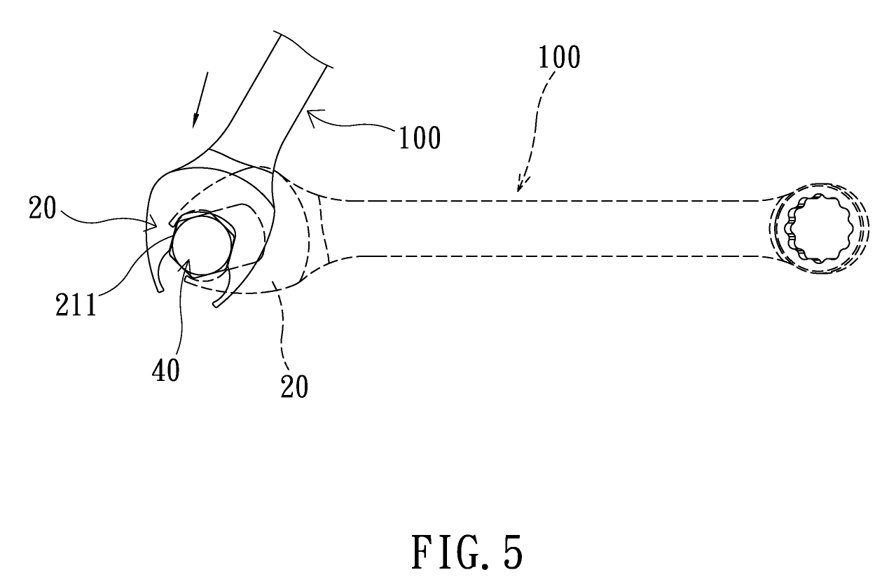

Referring to FIG. 5, the wrench 100 is moved in a direction indicated with an arrow head so that the driving portion 21 of the first head 20 is engaged with the fastener 40 again. That is, the wrench 100 is ready for another active stroke where the wrench 100 is operable to drive the fastener 40.

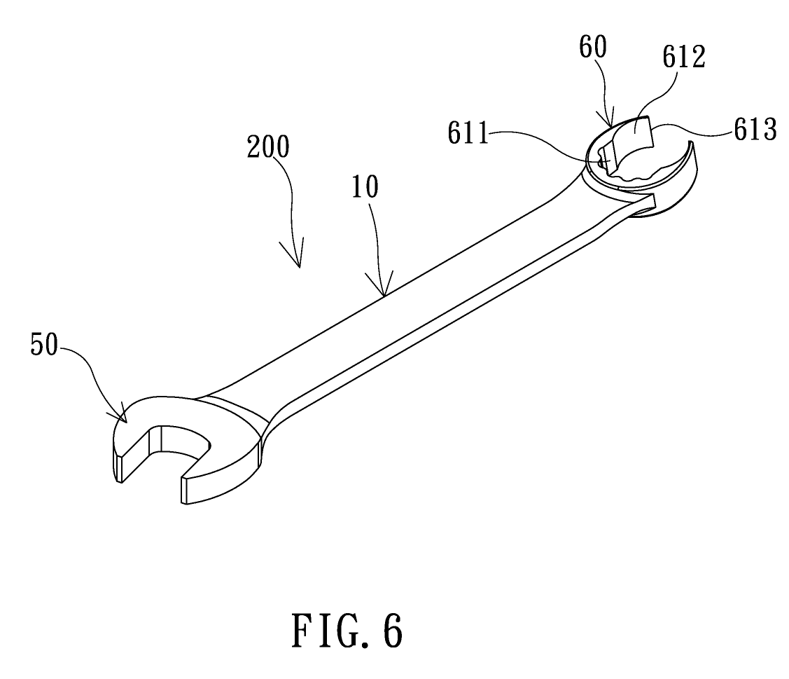

Referring to FIG. 6, a wrench 200 includes a handle 10, a first head 50 at a first end of the handle 10 and a second head 60 at a second end of the handle 10 according to a second embodiment of the present invention. The first head 50 includes two jaws for close contact with two facets of a fastener. The first head 50 is like an open end of a typical wrench so that it will not be described in detail. The second head 60 includes a driving portion 611, a retreating portion 612 and a mouth 613. The driving portion 611 is like the driving portion 21 except including recesses in addition to the parallel planar facets 211. The recesses are used to receive corners of the fastener 40. The retreating portion 612 will not be described in detail for being identical to the retreating portion 212. The mouth 613 will not be described in detail for being identical to the mouth 213.

As discussed, after an active stroke, without having to worry about disengaging the wrench from the fastener 40, the user can move the wrench 100 as shown in FIG. 3 so that the wrench 100 is ready for an idle stroke as shown in FIG. 4. After the idle stroke, the wrench 100 can easily be engaged with the fastener 40 again for another active stroke as shown in FIG. 5. Therefore, the operation of the wrench 100 is convenient and efficient.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A wrench comprising:
a handle; and
at least one head extending from an end of the handle and comprising:
a driving portion formed thereon and formed with two parallel facets separated from each other by a gap identical to a distance between two opposite facets of a polygonal head of a fastener;
a retreating portion formed near the driving portion and formed with two arched facets as two arcs of a circle with a diameter marginally larger than a distance between two opposite corners of the polygonal head of the fastener, wherein the driving portion is located closer to the handle than the retreating portion is; and
a mouth defined near the retreating portion and provided with a width marginally smaller than the gap.

2. The wrench according to claim 1, wherein the head is substantially in the form of an open head.

3. The wrench according to claim 2 comprising a boxed head extending from the handle opposite to the open head.

4. The wrench according to claim 1, wherein the driving portion of the head comprises recesses defined therein for receiving corners of a fastener.

5. The wrench according to claim 4, comprising an open head formed at another end of the handle.
